(19) United States
(12) Patent Application Publication
(10) Pub. No.: US 2007/0126564 A1
(43) Pub. Date: Jun. 7, 2007

(54) System and method for monitoring surrounding of vehicle

(75) Inventors: Youngjo Lee, Seoul (KR); Tiffany Uhm, La Habra, CA (US)

Correspondence Address: BACON & THOMAS, PLLC, 625 SLATERS LANE, FOURTH FLOOR, ALEXANDRIA, VA, 22314, US

(73) Assignee: Sonar Safety Systems, Inc., Sante Fe Springs, CA (US)

(21) Appl. No.: 11/332,347

(22) Filed: Jan. 17, 2006

(30) Foreign Application Priority Data
Dec. 7, 2005 (KR) 10-2005-0118571

(51) Int. Cl. B60Q 1/00

(52) U.S. Cl. 340/435

(57) ABSTRACT

A system for monitoring surroundings of a vehicle includes a plurality of sensors and cameras for detecting approach distances of the object and capturing the object in the rear area and the side areas of the vehicle. A control code generating unit calculates distance values from the sensed distances to produce a predetermined control code corresponding to a minimum distance and a control unit generates a monitoring image by operating any one of the cameras based on the control code to produce an OSD image adapted for warning an object's approach. The OSD image is mixed with the monitoring image to display the mixed result.

### FIELD OF THE INVENTION

The present invention relates to a system and a method for monitoring surroundings of a vehicle; and more particularly, to a system and a method for detecting an object approaching a rear side and both left and right sides of a vehicle and securing a visual field of a driver.

### BACKGROUND OF THE INVENTION

In general, a vehicle has a right and a left side mirror and a room mirror inside the vehicle. With the side mirrors and the room mirror, a driver can see a right side, a left side and a rear side of the vehicle while driving.

When the driver wants to change lanes while driving, the driver needs to check traffic conditions of a desired lane by using the right or the left side mirror and the room mirror. However, there exists a dead area where the driver cannot see with the side mirrors and the room mirror in a specific area of the side portions of the vehicle. Since the dead area existing in the side portions of the vehicle may threaten a safe driving, drivers generally turn their heads to check conditions of the dead area with eyes.

However, if a driver turns his/her head to check traffic conditions in the dead area, he/she temporarily loses a front view, which may lead a fatal result to a safety driving.

### SUMMARY OF THE INVENTION

It is, therefore, an object of the present invention to provide a system and a method for monitoring surroundings of a vehicle, capable of detecting an object's approach and visually and auditorily warning the driver an approach distance of the object from the vehicle.

In accordance with one aspect the invention, there is provided a system for monitoring surroundings of a vehicle, for monitoring an object's approaching condition in a rear area and side areas of the vehicle, the system comprising: a plurality of sensors for sensing approach distances of the object in the rear area and the side areas of the vehicle; means for calculating distance values from the sensed distances, selecting a minimum distance value from the calculated distance values and then changing the selected minimum distance value into a predetermined control code value; a plurality of cameras for capturing a rear image and side images of the rear area and the side areas of the vehicle in response to an image capture control signal; a control unit for generating a monitoring image by operating any one of the cameras with the image capture control signal generated based on the control code value and also for generating a visual alarm control signal for warning an object's approach from a right or a left side; means for generating a OSD image in response to the visual alarm control signal to provide a visual alarm; and a display for displaying on a display the monitoring image mixed with the OSD image.

In accordance with another aspect of the invention, there is provided a method for monitoring surroundings of a vehicle, the method comprising the steps of: sensing approach distances of the object in the rear area and the side areas of the vehicle and then calculating distance values from the sensed distances; selecting a minimum distance value between the vehicle and the object from the calculated distance values and then changing the selected minimum distance value into a control code value corresponding thereto; generating a monitoring image by selectively operating one of the plurality of cameras installed at specific positions of the rear area and the side areas of the vehicle based on the control code value; generating a OSD image based on the control code value to provide a visual alarm; and displaying on a display the monitoring image mixed with the OSD image.

### BRIEF DESCRIPTION OF THE DRAWINGS

The above and other objects and features of the present invention will become apparent from the following description of preferred embodiments, given in conjunction with the accompanying drawings, in which:

FIG. 1 is a block diagram of a system for monitoring surroundings of a vehicle in accordance with a preferred embodiment of the present invention;

FIG. 2 shows a flowchart describing a process of monitoring a rear side and both left and right sides of a vehicle with an ultrasonic sensor and a camera in the system shown in FIG. 1;

FIG. 3 provides a flowchart describing a process of monitoring a rear side and both left and right sides of a vehicle with an ultrasonic sensor and a camera when producing the reverse gear signal and/or direction indication rights in the system shown in FIG. 1;

FIG. 4 illustrates an exemplary monitoring image mixed with an OSD image provided only on one side of a screen in association with FIG. 2; and

FIG. 5 describes an exemplary monitoring image mixed with OSD images in association with FIG. 3.

### DETAILED DESCRIPTION OF THE PREFERRED EMBODIMENT

Hereinafter, preferred embodiments of the present invention will be described in detail with reference to the accompanying drawings.

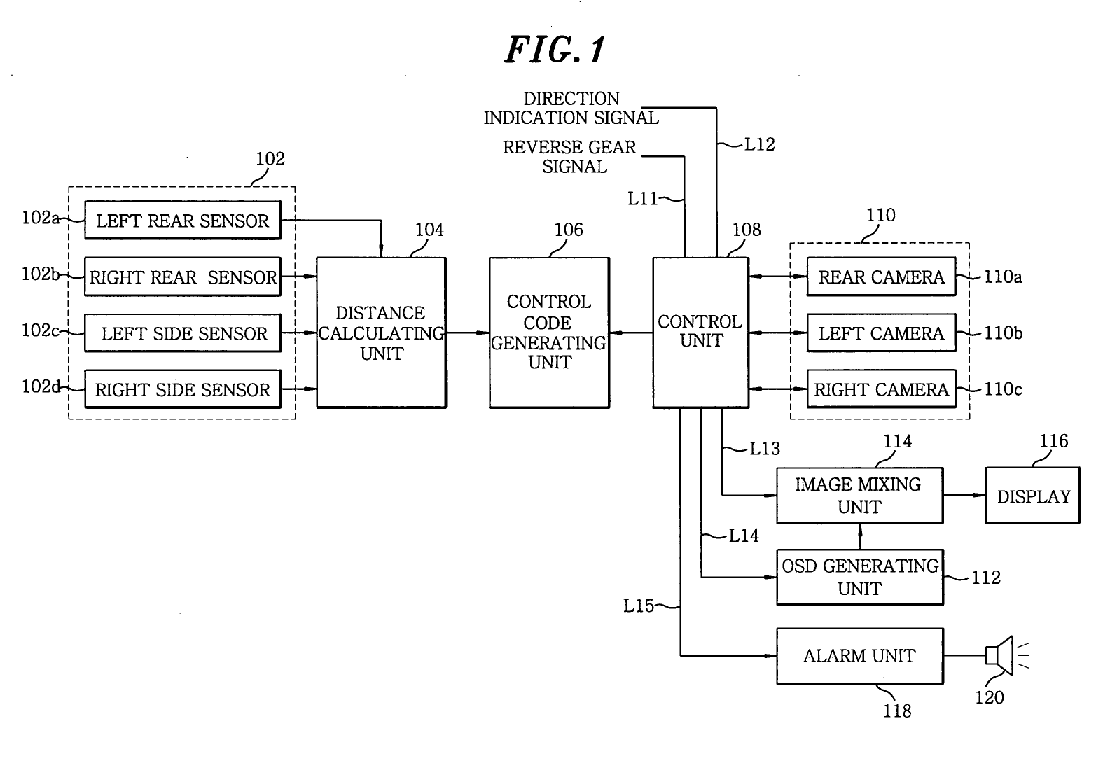

FIG. 1 is a block diagram of a system for monitoring surroundings of a vehicle in accordance with a preferred embodiment of the present invention. The system includes a sensing unit 102, a distance calculating unit 104, a control code generating unit 106, a control unit 108, an image capturing unit 110, an OSD unit 112, an image mixing unit 114, a display 116, an alarm unit 118 and a buzzer 120.

The sensing unit 102 includes a left rear sensor 102a, a right rear sensor 102b, a left sensor 102c and a right sensor 102d. Further, the image capturing unit 110 includes a rear camera 110a, a left camera 110b and a right camera 110c.

In the sensing unit 102, the left and the right rear sensor 102a and 102b are installed at a left and a right corner of a rear bumper of the vehicle, respectively, to detect, e.g., the object approaching the left and the right corner of the vehicle and neighboring areas thereof and a distance between the vehicle and the object. Detected distance signals indicating the object approaching the right and the left rear side are transferred to the distance calculating unit 104.

Further, the left rear and the right rear sensor 102c and 102d in the sensing unit 102, e.g., which are respectively installed at specific portions of the left and the right side of front or rear wheels of the vehicle, to detect the object approaching the left and the right side of the vehicle and the neighboring areas thereof and a distance between the vehicle and the object. Distance signals indicating the object approaching the left and the right side are transferred to the distance calculating unit 104.

As for the sensors employed in the sensing unit 102, there can be used an ultrasonic sensor, an infrared sensor or the like, for example. Moreover, instead of the sensors, the present invention may employ a radar, e.g., a pulse radar, a Doppler radar or the like, as a device for sensing the object.

In the present invention, the right and the left rear sensor 102b and 102a are installed at the right and the left corner of the rear bumper of the vehicle, and the right and the left sensor 102d and 102c are installed at specific locations of the right and the left side of the front and the rear wheels of the vehicle. However, the present invention is not limited thereto, and the installation position thereof may be randomly selected, if necessary.

The distance calculating unit 104 calculates distance values from the sensing signals provided from each of the sensors 102a, 102b, 102c and 102d in the sensing unit 102, i.e., the distance signals of the object approaching the right and the left rear portion and those of the object approaching the right and the left side. Thereafter, the information on the calculated distance values is transferred to the control code generating unit 106.

The control code generating unit 106 having a code table of control codes corresponding to the distance values calculated by the sensing of each sensor, e.g., 4-bit control codes, 6-bit control codes or the like, selects a minimum distance value from the distance values and then changes the selected minimum distance value into an n-bit control code. Likewise, the control code generating unit 106 generates the n-bit control code corresponding to the minimum distance value and then transfers it to the control unit 108.

In the meantime, the control unit 108, which may be implemented with a microprocessor or the like, functions to selectively control an operation of each camera in the image capturing unit 110 based on the transferred control codes and then provide a monitoring image obtained from the selected camera to the image mixing unit 114 via a line L13. Further, the control unit 108 generates control signals for visually and auditorily warning the object approaching the right and the left rear side and the right and the left side based on the transferred control codes. Then the control signals are provided to the OSD generating unit 112 and the alarm unit 118 via lines L14 and L15, respectively.

In other words, the rear camera 110a in the image capturing unit 110, which is installed at, e.g., an upper portion of a trunk lid, a central portion of a rear bumper or the like, performs a signal processing of a captured image from the rear area of the vehicle in response to an image capture control signal obtained from the control unit 108 and then provides the signal-processed image to the control unit 108 as a monitoring image.

Further, the right and the left camera 110c and 110b, which is installed at, e.g., specific locations of the side mirrors of the vehicle, perform the signal-processing of captured images from the right and the left area of the vehicle in response to an image capture control signals obtained from the control unit 108 and then provide the signal-processed images to the control unit 108 as monitoring images.

Here, as for the cameras employed in the image capturing unit 110, there can be used a CCD camera, a video camera, a digital camera or the like, for example.

Meanwhile, the control unit 108 checks whether or not a reverse gear signal indicating the operation of a reverse gear or a direction indication signal indicating the operation of a direction indicator such as a right turn signal or a left turn signal is inputted through a line L11 or L12 during a monitoring mode for generating the monitoring image with an operation of any one of the rear camera 110a, the left camera 110b and the right camera 110c based on the control codes. If it is checked that the related signal is inputted, the control code generating unit 106 is controlled so that an object approach distance signal sensed by the sensor installed at a position corresponding to the related signal is forcibly determined as a final distance value and, then, a forced monitoring mode for generating a monitoring image with a forced operation of the camera installed at a position corresponding to the related signal is implemented.

For instance, on the assumption that the distance value obtained from the right side sensor 102d is a minimum distance value and thus the monitoring image is generated with the operation of the right camera, if the left turn signal is inputted by a driver's manipulation, the distance value transferred from the left side sensor 102c is determined as a final distance value and, then, a control code value corresponding thereto is generated. Thereafter, the forced monitoring mode is performed to provide as a monitoring image the image obtained by operating the left camera 110b after stopping the operation of the right camera 110c.

In other words, in accordance with the present invention, if the driver puts a car in the reverse gear or turns on the right or the left turn signal during the monitoring mode for visually and auditorily warning the driver with the minimum distance value selected from the distance values sensed by the respective sensors and the monitoring image captured by the camera deriving the minimum distance value, the forced monitoring mode for forcibly selecting the distance value and operating the camera based on the driver's manipulation is implemented.

The OSD generating unit 112 generates an OSD image for a visual alarm, e.g., an OSD image having a green G area, a yellow Y area and a red R area selectively turned on/off depending on an approach distance of the object in response to the visual alarm control signal provided from the control unit 108 via a line L14. Such generated OSD image is transferred to the image mixing unit 114. Herein, the green area, the yellow area and the red area are displayed to be turned on/off separately depending on the control code value corresponding to the minimum distance value (or the final distance value).

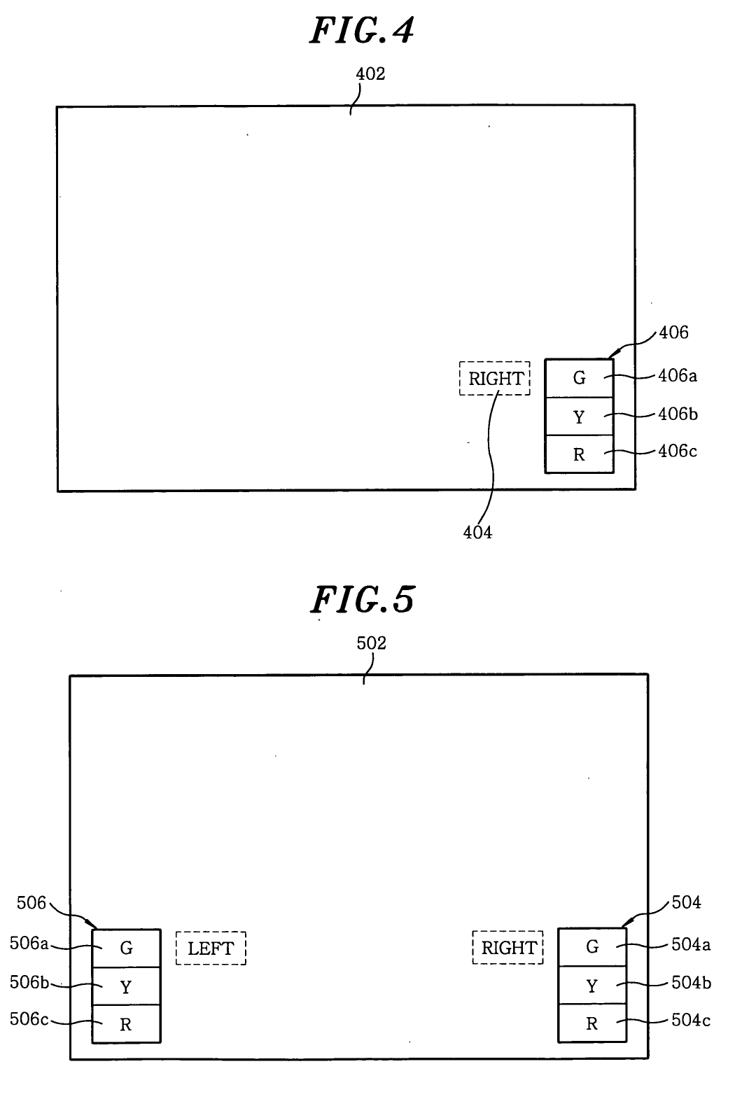

The image mixing unit 114 mixes the monitoring image provided from the control unit 108 via a line L13 with the OSD image provided from the OSD generating unit 112 and then transfers the mixed result to the display 116. As indicated in FIG. 4, the OSD image is positioned on the lower right portion or on the lower right and the lower left portion of the screen. Further, the OSD image is preferably configured to be semitransparent so that the driver can see overlapped areas of the monitoring image.

As a result, as illustrated in FIGS. 4 and 5, the monitoring image mixed with the OSD image is displayed on the display 116. In FIGS. 4 and 5, there are shown reference numerals 402 and 502 indicating monitoring image areas captured by the cameras; reference numeral 404 representing a right and a left indication area; reference numerals 406, 504 and 506 depicting the OSD image areas; reference numerals 406a, 504a and 506a indicating the green G areas; reference numerals 406b, 504b and 506b presenting the yellow Y areas; and reference numerals 406c, 504c and 506c representing the red R areas.

According to the present invention, the green area, the yellow area and the red area is configured to be sequentially turned on and off as the distance between the vehicle and the object becomes closer. For example, in case the distance between the vehicle and the object is 9 feet, the green area is exclusively configured as the OSD image and turned on and off at specific time intervals (e.g., 0.5 seconds or the like). In case the distance between the vehicle and the object is 5 feet, the green area is exclusively configured as the OSD image and turned on and off at shorter specific time intervals (e.g., 0.4 seconds or the like). Further, in case the distance between the vehicle and the object is 3-4 feet, the green area and the yellow area are configured as the OSD image, and the yellow area is exclusively turned on and off at specific time intervals (e.g., 0.3 seconds or the like). Moreover, in case the distance between the vehicle and the object is 2 feet, the green area, the yellow area and the red area are configured as the OSD image, and the red area is exclusively turned on and off at specific time intervals (e.g., 0.1 seconds or the like). Furthermore, in case the distance between the vehicle and the object is smaller than or equal to 1 feet, the green area, the yellow area and the red area are configured as the OSD image and turned on and off at specific time intervals (e.g., 0.1 seconds or the like). In this manner, the driver can be visually warned of the object's approach. Further, the distance value (e.g., “9 FT”, “5 FT”, “4 FT”, “3 FT”, “2 FT”, “1 FT” or the like) between the vehicle and the object may be set to be displayed on a neighboring area of the OSD image.

Therefore, the driver can visually recognize the distance between a random object and the vehicle by the selective on/off state of the color of the OSD image in the monitoring image displayed on the display 116.

In the meantime, the alarm unit 118 generates an interrupted noise or a continuous noise for auditorily warning the driver of the object's approach in response to an auditory alarm control signal provided from the control unit 108 via a line L15 (i.e., based on the control code value corresponding to the minimum distance value or the final distance value) and then outputs the noise to the buzzer 120. Accordingly, the driver can be warned of a random object approaching the vehicle by the interrupted noise (the interrupted noise is generated at long intervals as the distance between the vehicle and the object becomes wider, whereas it is generated at shorter intervals as the distance therebetween becomes closer) or the continuous noise. Here, the buzzer 120 can be replaced by a speaker of an audio system installed inside the vehicle.

That is, the alarm unit 118 generates the intermittent noise at regular intervals when the object approaching the vehicle is sensed. At this time, as the distance between the object and the vehicle becomes closer, the driver is warned of the object's approach by the interrupted sound generated at short intervals. When the distance therebetween reaches a predetermined approach distance (e.g., 1 feet or the like), the driver is warned by the continuous noise to be recognized such an imminent situation.

Therefore, the driver can auditorily recognize the approach distance between a random object and the vehicle by the intermittent noise or the continuous noise outputted from the buzzer 120.

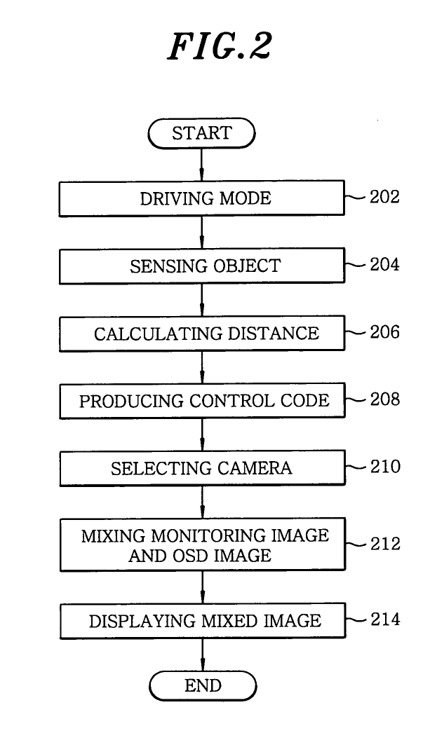

FIG. 2 shows a flow chart describing a process of monitoring a rear side and both right and left side of a vehicle with an ultrasonic sensor and a camera in the system shown in FIG. 1.

A control process begins with a step 202 where the vehicle is driven in a driving mode by starting an engine of the vehicle. During the driving mode, if an object approaches the vehicle, it is sensed by the sensors installed at proper positions of the vehicle in step 204. Then, in step 206, distance values are calculated from the object approach distance signals by the distance value calculation unit 104 and then transferred to the control code generating bock 106.

Next, in the control code generating unit 106 having a code table of n-bit control codes corresponding to the calculated distance values, a minimum distance value is selected among those distance values. Thereafter, the minimum distance value is changed into an n-bit control code corresponding thereto by using the code table and then transferred to the control unit 108 in step 208.

The control code 108 selects a camera based on the transferred control code. For example, if the minimum distance value corresponding to the control code is obtained from the left sensor 102c, an image capture control signal for enabling the left camera 110b is generated and, thus, the left camera 110b is operated in step 210. As a result, the image of the left area of the vehicle is captured by the left camera 110b, and is then transferred as a monitoring image to the image mixing unit 114 via the control unit 108.

Thereafter, the OSD image generated by the OSD generating unit 112 is transferred to the image mixing unit 114 under the control of the control unit 108. Further, the image mixing unit 114 mixes the monitoring image provided from the control unit 108 with the OSD image provided from the OSD generating unit 112 and then transfers the mixed result to the display 16 in step 212. At this time, as shown in FIGS. 4 and 5, the monitoring image is mixed with the OSD image. In this connection, the respective green areas 406a, 504a and 506a, yellow areas 406b, 504b and 506b and red areas 406c, 504c and 506c are displayed to be selectively turned on/off based on the control code value (i.e., the distance value between the vehicle and the object) in step 214.

Accordingly, the driver can visually recognize the approach distance between a random object and the vehicle by the selective on/off state of the color of the monitoring image mixed with the OSD image displayed on the display 116.

In other words, in accordance with the present invention, the OSD image is displayed only on one side (lower right portion) of the monitoring image, as depicted in FIG. 4, or on both sides (lower right and lower left portion) of the monitoring image, as illustrated in FIG. 5. In case the OSD image is provided only on one side of the monitoring image, the right and left indication area 404 for distinguishing directions needs to be included in the monitoring image.

Although the auditory information on the approach distance between the vehicle and the object has not been described with reference to FIG. 2, it is understood that when the OSD image is generated and displayed based on the distance value between the vehicle and the object, the auditory information such as the intermittent noise or the continuous noise is implemented by the buzzer.

The following is a description of a process for providing the visual information to the driver with the OSD image having a selective combination of the green area, the yellow area and the red area selectively turned on/off based on the distance value between the vehicle and the object.

First of all, on the assumption that the sensors are installed at the right and the left corner of the rear bumper of the vehicle and also set to sense the distances of 9 FT, 5 FT, 4 FT, 3 FT, 2 FT and 1 FT with the use of the 4-bit control codes, the visual information (the OSD image) on the object approaching the vehicle is described as in a following table.

TABLE

| | | | | | on/off |
|---|---|---|---|---|---|
| Control | | | OSD | | interval |
| code | Distance | Direction | image | State | (sec) |
| 0001 | 9 FT | Right | G | G on | 0.5 |
| | | | | and off | |
| 0010 | 0 FT | Left | G | G on | 0.5 |
| | | | | and off | |
| 1010 | 5 FT | Right | G | G on | 0.4 |
| | | | | and off | |
| 1100 | 5 FT | Left | G | G on | 0.4 |
| | | | | and off | |
| 0011 | 4 FT | Right | G Y | G on, Y | 0.3 |
| | | | | on and off | |
| 0100 | 4 FT | Left | G Y | G on, Y | 0.3 |
| | | | | on and off | |
| 1101 | 3 FT | Right | G Y | G on, Y | 0.3 |
| | | | | on and off | |
| 1011 | 3 FT | Left | G Y | G on, Y | 0.3 |
| | | | | on and off | |
| 0101 | 2 FT | Right | G Y R | G Y on, | 0.1 |
| | | | | R on | |
| | | | | and off | |
| 0110 | 2 FT | Left | G Y R | G Y on, | 0.1 |
| | | | | R on | |
| | | | | and off | |
| 1001 | 1 FT | Right | G Y R | G Y R on | 0.1 |
| | | | | and off | |
| 1000 | 1 FT | Left | G Y R | G Y R on | 0.1 |
| | | | | and off | |
| 1111 | X | X | X | “SONA”, | 0.5 |
| | | | | “OK” | (2-3 |
| | | | | | times) |
| 0111 | X | X | X | “NO SIG” | 1 |
| 0000 | X | Right | X | “SONA”, | 1 |
| | | | | “ERROR” | |
| 1110 | X | Left | X | “SONA”, | 1 |
| | | | | “ERROR” | |

Referring to the table, the control code “0001” indicates that the right sensor senses an object within 9 feet (FT) and, thus, the OSD image composed of the green G area is generated, wherein the green G area is turned on and off at 0.5 second intervals on the screen of display 116. At this time, a buzzer sound for the auditory alarm is generated as the interrupted noise with a repetition of, e.g., 0.7 KHz pulse, 30 msec ON and 70 msec delay cycle.

Further, the control code “0010” indicates that the left sensor senses an object within 9 FT and, thus, the OSD image composed of the green G area is generated, wherein the green G area is turned on and off at 0.5 second intervals on the screen of display 116. At this time, a buzzer sound for the auditory alarm is generated as the interrupted noise equal to that generated in the control code “0001”.

Moreover, the control code “1010” represents that the right sensor senses an object within 5 FT and, thus, the OSD image composed of the green G area is generated, wherein the green G area is turned on and off at 0.4 second intervals on the screen of display 116. At this time, a buzzer sound for the auditory alarm is generated as the interrupted noise equal to that generated in the control code “0001”.

The control code “1100” indicates that the left sensor senses an object within 5 FT and, thus, the OSD image composed of the green G area is generated, wherein the green G area is turned on and off at 0.4 second intervals on the screen of display 116. At this time, a buzzer sound for the auditory alarm is generated as the interrupted noise equal to that generated in the control code “0001”.

Furthermore, the control code “0011” indicates that the right sensor senses an object within 4 FT and, thus, the OSD image composed of the green G area and the yellow Y area is generated, wherein the green G area is turned on, whereas the yellow Y area is turned on and off at 0.3 second intervals on the screen of display 116. At this time, a buzzer sound for the auditory alarm is generated as the interrupted sound with a repetition of, e.g., 3 KHz pulse, 12 msec ON and 70 msec delay cycle.

The control code “0100” indicates that the left sensor senses an object within 4 FT and, thus, the OSD image composed of the green G area and the yellow Y area is generated, wherein the green G area is turned on, whereas the yellow Y area is turned on and off at 0.3 second intervals on the screen of display 116. At this time, a buzzer sound for the auditory alarm is generated as the interrupted noise equal to that generated in the control code “0011”.

Besides, the control code “1101” indicates that the right sensor senses an object within 3 FT and, thus, the OSD image composed of the green G area and the yellow Y area is generated, wherein the green G area is turned on, whereas the yellow Y area is turned on and off at 0.3 second intervals on the screen of display 116. At this time, a buzzer sound for the auditory alarm is generated as the interrupted noise equal to that generated in the control code “0011”.

In addition, the control code “1011” indicates that the left sensor senses an object within 3 FT and, thus, the OSD image composed of the green G area and the yellow Y area is generated, wherein the green G area is turned on, whereas the yellow Y area is turned on and off at 0.3 second intervals on the screen of display 116. At this time, a buzzer sound for the auditory alarm is generated as the interrupted noise equal to that generated in the control code “0011”.

The control code “0101” indicates that the right sensor senses an object within 2 FT and, thus, the OSD image composed of the green G area, the yellow Y area and the red R area is generated, wherein the green G area and the yellow Y area are turned on, whereas the red R area is turned on and off at 0.1 second intervals on the screen of display 116. At this time, a buzzer sound for the auditory alarm is generated as the interrupted noise with a repetition of, e.g., 1 KHz pulse, 20 msec ON and zero delay cycle.

Further, the control code “0110” indicates that the left sensor senses an object within 2 FT and, thus, the OSD image composed of the green G area, the yellow Y area and the red R area is generated, wherein the green G area and the yellow Y area are turned on, whereas the red R area is turned on and off at 0.1 second intervals on the screen of display 116. At this time, a buzzer sound for the auditory alarm is generated as the interrupted noise equal to that generated in the control code “0101”.

Furthermore, the control code “1001” indicates that the right sensor senses an object within 1 FT and, thus, the OSD image composed of the green G area, the yellow Y area and the red R area is generated, wherein the green G area, the yellow Y area and the red R area are turned on and off at 0.1 second intervals on the screen of display 116. At this time, a buzzer sound for the auditory alarm is generated as the continuous noise instead of the interrupted noise.

The control code “1000” indicates that the left sensor senses an object within 1 FT and, thus, the OSD image composed of the green G area, the yellow Y area and the red R area is generated, wherein the green G area, the yellow Y area and the red R area are turned on and off at 0.1 second intervals on the screen of display 116. At this time, a buzzer sound for the auditory alarm is generated as the continuous noise instead of the interrupted noise.

The control code “1111” indicates a self diagnosis function. In case the monitoring system is self-diagnosed as normal, messages of “SONA” and “OK” are displayed on a central portion of the screen of the display 116 at approximately 0.5 second intervals 2-3 times. At this time, the buzzer generates beeps for about 1 second.

Further, the control code “0111” indicates a normal state, i.e., a state where no sensing signal is sensed by each of the sensors. At this time, a message of “NO SIG” is turned on and off on a lower central portion of the screen of the display 116 at approximately 1 second intervals.

The control code “0000” indicates that an error occurs in sensing the object approaching from the right side. At this time, messages of “SONA” and “ERROR” are turned on and off on the lower central portion and on the right side of the screen of the display 116 at approximately 1 second intervals. Further, the buzzer generates the continuous noise for about 10 seconds.

The control code “1110” indicates that an error occurs in sensing the object approaching from the left side. At this time, message of “SONA” and “ERROR” are turned on and off on the lower central portion and on the right side of the screen of the display 116 at about 1 second intervals. Further, the buzzer generates the continuous noise for about 10 seconds.

In accordance with the present invention, the distance between the vehicle and the object is sensed by the sensors, and an area to be captured is determined based on the sensed distance value. Moreover, based on the sensed distance value and the captured image, the monitoring image including the OSD image (the OSD image in which a green, a yellow and a red color are selectively turned on/off) is generated and then displayed on the display 116. In this manner, the driver is warned of the distance between the vehicle and the object. Accordingly, it is possible to effectively prevent traffic accidents that may be caused by the dead area when the driver is driving and minor collisions that may occur when the driver is driving backward.

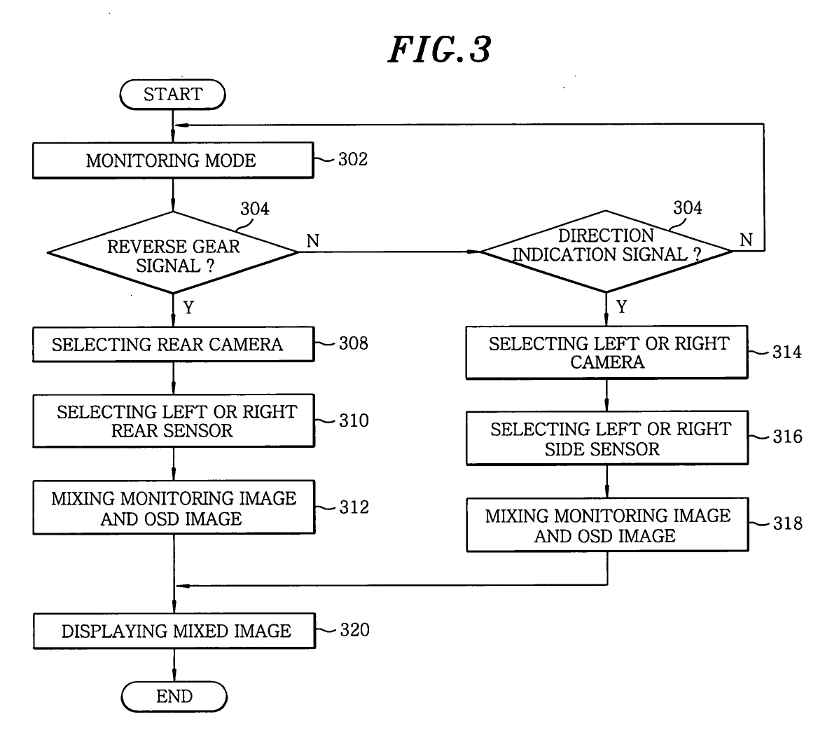

Although the present invention has described a case where the monitoring image is generated by operating a camera in a corresponding area based on the distance value sensed by the sensor, the present invention is not limited thereto. That is, the monitoring image can also be generated in synchronization with the reverse gear signal, the direction indication signal or the like. A detailed description thereof will be explained with respect to FIG. 3.

Referring to FIG. 3, while the monitoring mode is performed through the same steps illustrated as in FIG. 2 in step 302, the control unit 108 checks whether or not a reverse gear signal or a direction indication signal is inputted from surroundings in steps 304 and 306.

If it is checked, in the step 304, that the reverse gear signal is produced, the control unit 108 changes the monitoring mode into a forced monitoring mode. For example, if the left sensor 102c senses a minimum distance value between the vehicle and the object and, thus, the reverse gear signal is inputted during the monitoring mode for operating the left camera 110b, the control unit 108 forcibly stops the operation of the left camera 110b and operates the rear camera 110a. Then, there is performed the forced monitoring mode for selecting the distance value sensed by the right or the left rear sensor 102b or 102a as a final distance value in steps 308 and 310.

Consequently, the image captured by the rear camera 110a is configured as the monitoring image. The monitoring image is mixed with the OSD image generated based on the control code value corresponding to the distance value sensed by the right or the left rear sensor 102b and 102a and, then, the mixed result is displayed on the display 116 in steps 312 and 320.

Therefore, the driver can recognize the circumstances in the rear area of the vehicle and the object approach information through the screen of the display 116 while driving backward, thereby enabling to effectively prevent the minor accidents that may occur when the driver is driving backward.

In the meantime, if it is checked, in the step 306, that the direction indication signal, e.g., a right turn signal, is inputted from surroundings, the control unit 108 changes the monitoring mode into the forced monitoring mode. For example, if the left side sensor 102c senses a minimum distance value between the vehicle and the object and, accordingly, the right turn signal is produced during the monitoring mode for enabling the left camera 110b, the control unit 108 forcibly stops the operation of the left camera 110b and operates the right camera 110c. Then, the forced monitoring mode for selecting the distance value sensed by the right sensor 102d as a final distance value is implemented in steps 314 and 316.

Consequently, the image captured by the right camera 110c is configured as the monitoring image. The monitoring image is mixed with the OSD image generated based on the control code value corresponding to the distance value sensed by the right sensor 102d and, then, the mixed result is displayed on the display 116 in steps 318 and 320.

Therefore, the driver can recognize the circumstances in the rear area of the vehicle and the object approach information through the screen of the display 116 while turning right, thereby enabling to effectively prevent the minor accidents that may occur when the vehicle is turning right.

In accordance with the present invention, the driver is warned of the distance between the vehicle and the object by the monitoring image displayed on the display based on the reverse gear signal or the direction indication signal, the monitoring image including the OSD image (the OSD image in which a green, a yellow and a red color are selectively turned on/off) having information on the circumstances of the corresponding areas (a rear, a right and a left area of the vehicle) and the object approach distance. Accordingly, it is possible to effectively prevent the minor collisions that may occur when the driver is turning right or left.

In this preferred embodiment, when the reverse gear signal is produced, the camera and the sensor installed at the rear of the vehicle operate. However, the present invention is not limited thereto. That is, when the driver puts the car in the reverse gear, he/she can select and operate a camera based on the final distance value selected from distance values sensed by the rear sensor. This is also applicable to the case where the direction indication signal is inputted.

As described above, in accordance with the present invention, unlike the aforementioned prior art in which a rear view and side views of a vehicle are obtained by side mirrors installed at a right and a left side of a vehicle and a room mirror installed inside the vehicle, the present invention has sensors and cameras installed at the rear portion and the side portions of the vehicle. Thus, the present invention generates a monitoring image based on a distance between the vehicle and the object, which is sensed by the sensors in an object's approaching direction, and then mixes the monitoring image with a visual warning image (OSD image). By displaying the mixed monitoring image on the display, a driver can be visually and auditorily warned of the object approaching the rear portion and the side portions of the vehicle. As a result, it is possible to effectively prevent traffic accidents that may occur when the driver is driving and minor collisions that may occur when the driver is driving backward or turning right or left.

While the invention has been shown and described with respect to the preferred embodiments, it will be understood by those skilled in the art that various changes and modification may be made without departing from the scope of the invention as defined in the following claims.

What is claimed is:

1. A system for monitoring surroundings of a vehicle, for monitoring an object's approaching condition in a rear area and side areas of the vehicle, the system comprising:
a plurality of sensors for sensing approach distances of the object in the rear area and the side areas of the vehicle;
means for calculating distance values from the sensed distances, selecting a minimum distance value from the calculated distance values and then changing the selected minimum distance value into a predetermined control code value;
a plurality of cameras for capturing a rear image and side images of the rear area and the side areas of the vehicle in response to an image capture control signal;
a control unit for generating a monitoring image by operating any one of the cameras with the image capture control signal generated based on the control code value and also for generating a visual alarm control signal for warning an object's approach from a right or a left side;
means for generating a OSD image in response to the visual alarm control signal to provide a visual alarm; and
a display for displaying on a display the monitoring image mixed with the OSD image.

2. The system of claim 1, wherein the plurality of sensors includes:
a left rear sensor for sensing an object's approach in a left rear area of the vehicle;
a right rear sensor for sensing the object's approach in a right rear area of the vehicle;
a left sensor for sensing the object's approach in a left side area of the vehicle; and
a right sensor for sensing the object's approach in a right side area of the vehicle.

3. The system of claim 2, wherein the respective sensors includes any one among an ultrasonic sensor, an infrared sensor, a pulse radar, and a Doppler radar.

4. The system of claim 1, wherein the plurality of cameras includes:
a rear camera, in response to the image capture control signal, for capturing a rear area of the vehicle to provide the captured image to the control unit;
a left camera, in response to the image capture control signal, for capturing a left area of the vehicle to provide the captured image to the control unit; and
a right camera, in response to the image capture control signal, for capturing a right area of the vehicle to providing the captured image to the control unit.

5. The system of claim 4, wherein the respective cameras includes any one among an ultrasonic sensor, an infrared sensor, a pulse radar, and a Doppler radar.

6. The system of claims 2, further comprising:
means for forcibly operating, when a reverse gear signal or a direction indication signal is inputted, a camera installed at a position corresponding to the inputted reverse gear signal or direction indication signal; and
means for forcibly determining as the minimum distance value a distance value sensed by a sensor installed at a position corresponding to the inputted reverse gear signal or direction indication signal.

7. The system of claims 1, further comprising means for generating an interrupted noise or a continuous noise for an auditory alarm based on the determined minimum distance value.

8. The system of claims 1, wherein the OSD image is one having a green G area, a yellow Y area and a red R area, each being selectively turned on/off depending on the approach distances of the object.

9. A method for monitoring surroundings of a vehicle, the method comprising the steps of:
sensing approach distances of the object in the rear area and the side areas of the vehicle and then calculating distance values from the sensed distances;
selecting a minimum distance value between the vehicle and the object from the calculated distance values and then changing the selected minimum distance value into a control code value corresponding thereto;
generating a monitoring image by selectively operating one of the plurality of cameras installed at specific positions of the rear area and the side areas of the vehicle based on the control code value;
generating an OSD image based on the control code value to provide a visual alarm; and
displaying on a display the monitoring image mixed with the OSD image.

10. The method of claim 9, further comprising the steps of:
checking whether or not a reverse gear signal or a direction indication signal is inputted from surroundings;
forcibly determining, when the reverse gear signal or a direction indication signal is inputted, as the minimum distance value a distance value sensed by a sensor installed at a corresponding position; and
generating the monitoring image by forcibly operating a camera installed at a corresponding position when the reverse gear signal or the direction indication signal is inputted.

11. The method of claim 9, further comprising the step of generating an auditory alarm based on the determined minimum distance value.

12. The method of claim 9, wherein the OSD image is one having a green G area, a yellow Y area and a red R area, each being selectively turned on/off depending on the approach distances of the object.
